(19) United States
(12) Patent Application Publication
(10) Pub. No.: US 2003/0108276 A1
(43) Pub. Date: Jun. 12, 2003

(54) Switchable reflective optical component

(76) Inventor: Adrian P. Janssen, Exeter (GB)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/006,508

(22) Filed: Dec. 6, 2001

(51) Int. Cl. G02B 6/35; G02B 6/26; G02B 7/198

(52) U.S. Cl. 385/18; 385/17; 385/140; 359/872

(57) ABSTRACT

An optical component has at least one cell with a mirror electrode and a counter electrode, and an electrolyte disposed between the mirror and counter electrodes which includes metal ions which are depositable onto the mirror and counter electrodes. The cell is operable in a reflective and a transmissive mode by depositing different quantities of the metal ions on to the mirror electrode. An input optical signal can thus be selectively reflected, without requiring movement of mechanical components, instead relying on the flow of electrolyte ions. By providing a reflection state and a transmission state, the cell can act as a switchable micromirror for signal routing or monitoring functions

### FIELD OF THE INVENTION

The invention relates to optical components which provide switchable reflection of an optical signal.

### BACKGROUND OF THE INVENTION

Optical communication systems require high speed data, implemented as optical signals, to be switched between ports of a switching device to provide a signal routing function. Typically, the optical signals are carried by optical fibers, which connect to the optical switching device. There are currently a number of methods for achieving the required switching operation.

One solution comprises an electromechanical arrangement, where a signal in one optical fiber is routed to another fiber by mechanically aligning the two fibers. This arrangement is bulky and mostly suited only to 1×N switch configurations.

An alternative solution is to use a hybrid optical switch in which the optical signals are first converted to electrical signals which are switched in a conventional manner. The resulting outputs of the switch are then converted back to optical signals. This adds complexity and noise to the switching operation.

Optical switches are also known in which a control signal is used to vary the path of an optical signal. For example, waveguide-based switches rely on the change of refractive indices in the waveguides under the influence of an external electric field, current or other signal.

Optical switches using an array of mirrors which can be mechanically tilted are also known. Small micromirrors (for example less than 1 mm) are arranged in a line or array, and the incident light signal is deflected by controlling the tilt angle of each micromirror. Mirror type optical switches include digital micromirror devices which tilt each micromirror by electrostatic force, piezoelectric, drive micromirror devices which tilt each microirirror by a fine piezoelectric element and electromagnetic devices which rely upon electromagnetic and electrostatic forces.

In a typical micromirror device, a plurality of micromirrors are arranged in an array of N×M mirrors Each micromirror can be controlled and is capable of switching between a first reflection state and a second non-reflection state. The optical signal is routed between an input and a selected output by controlling the reflection state of each mirror,

These micromirror devices require high angular or positional precision in the orientation of the mirrors, for example better than 0.05 degrees. The coupling of the signal carrying fibers to the micromirror array with the required accuracy also presents difficulties.

It is often desirable to perform monitoring operations on an optical signal, such as optical power measurement or spectral analysis. This is conventionally performed by tapping a small proportion of the optical power of a signal and routing this to the required monitoring equipment.

### SUMMARY OF THE INVENTION

According to the invention, there is provided an optical component for operating on an optical signal within an optical communications system, the component comprising at least one cell having a mirror electrode and a counter electrode, an electrolyte disposed between the mirror and counter electrodes which includes metal ions which are depositable onto the mirror and counter electrodes, wherein the cell is operable in at least two modes providing different reflection and transmission characteristics by depositing different quantities of the metal ions on to the mirror electrode.

This component enables an optical signal at the input of the component to be selectively reflected, without requiring movement of mechanical components, instead relying on the flow of electrolyte ions. By providing a reflection state and a transmission state, the cell can act as a switchable micromirror. For example, the mirror electrode can be planar, and the one mode is then for substantially reflecting an input signal and the other mode is for substantially transmitting an input signal.

A switchable mirror array can then comprise a plurality of these components together defining an array of cells arranged in rows and columns. The mirror array has a plurality of inputs, each aligned with a row of cells, and a plurality of outputs each aligned with a column of cells. This provides a two dimensional mirror array. The mirror surfaces can be provided on a pre-aligned plate, and the mirror alignment remains fixed as the mirror is switched on and off.

The inputs may be aligned at 90 degrees to the outputs, and the mirror electrode of each cell is aligned at 45 degrees to the inputs and outputs. Each mirror electrodes either allow the passage of the input signal or else redirect the input signal by 90 degrees towards an output. The inputs and outputs preferably comprise optical fiber ports.

The mirror array can be fabricated by stacking optical components on top of each other, each optical component having a plurality of cells arranged in a line. This provides a simple structure for the two dimensional array.

Instead of forming a planar mirror electrode for routing an optical signal from an input to an output, the mirror electrode may be curved to define a reflective lens surface or a reflective Fresnel lens surface. One mode is then for substantially reflecting an input signal and focusing it, and the other mode is for substantially transmitting an input signal.

The component can then be used to selectively reflect and focus an input signal onto a detector, for example for periodic optical power monitoring. The component is in-line with the optical signal and does not require a separate tapping arrangement. When turned off (in the transmission mode) the component can provide minimal attenuation of the optical signal passing through the component.

In another embodiment, the mirror electrode is shaped to define a diffraction grating surface, and wherein one mode is for providing a reflected dispersed spectrum, and the other mode is for substantially transmitting an input signal.

The component can then be used to selectively reflect a dispersed spectrum for optical spectrum analysis.

The component can be used as a variable optical attenuator by driving the cell to any intermediate state between the most transmissive and most reflective modes.

The invention also provides a method of operating on an optical signal within an optical communications system, comprising:

aligning the signal with a cell having a mirror electrode and a counter electrode and an electrolyte disposed between the mirror and counter electrodes which includes metal ions which are depositable onto the mirror and counter electrodes;

selectively operating the cell in one of at least two modes, the at least two modes providing different reflection and transmission characteristics by depositing different quantities of metal ions on to the mirror electrode.

### BRIEF DESCRIPTION OF THE DRAWINGS

Examples of the invention will now be described in detail with reference to the accompanying drawings, in which:

FIG. 1 shows an optical reflecting component of the invention;

FIG. 2 is used to explain the deposited metal layer thickness required for reflection;

FIG. 3 shows how metal thickness can be used as a control parameter for controlling reflectance;

FIG. 4 shows a control scheme for providing variable reflectance;

FIG. 5 shows a 2D micromirror array in accordance with the invention;

FIG. 6 shows two examples of a reflecting focussing device according to the invention; and

FIG. 7 shows a reflecting diffraction grating according to the invention,

### DETAILED DESCRIPTION

FIG. 1 shows an optical component 10 of the invention. An optical signal 12 is provided to the component, for example from an optical fiber. Typically, the signal is a channel or group of channels of a WDM optical signal. The component 10 either allows the signal 12 to pass through as a transmitted output 14 or else reflects the signal as a reflected output 16. As will be seen below, the component can be controlled to provide a variable amount of transmission and reflection. Although it can be considered that the device has a transmitting mode and a reflecting Mode, it will be understood that there will be some signal attenuation within the component so that there will never be 100% transmittance, and when in a reflection mode, there will not be 100% reflectance.

The component 10 comprises a cell in which an electrolyte 20 is contained. The cell volume is defined between front and back glass plates 22,24 and a ceramic or glass side wall 26.

The inner surface of the front glass plate 22 is provided with a transparent conducting coating 28, acting as a mirror electrode to which an external current or voltage can be applied at terminal 30. This conducting coating 28 covers the inner surface of the front glass plate. in one example, the coating comprises ITO.

The inner surface of the rear glass plate 24 is also provided with a conducting coating 32 acting as a counter electrode, but which extends only around a periphery of the rear glass plate, so that an opening 34 is provided through which the signal 12,14 can pass. An external current or voltage can be applied to the coating 32 at terminal 36. The coating 32 does not need to be transparent and can comprise any suitable metal.

The outer surfaces of the front and rear glass plates 22,24 are provided with anti-reflection coatings (not shown).

The electrolyte includes metal ions which are depositable onto the mirror and counter electrodes A voltage applied between the two electrodes causes electrodeposition of a metal deposit on one electrode and dissolution of the metal deposit on the other electrode. This operation is reversible, so that the application of suitable signals to the terminals 30,36 can result in the available metal ions depositing either on the mirror electrode or on the counter electrode. As shown in FIG. 1, when the metal ions deposit on the counter electrode, they collect in an annulus 37, with the opening 34 allowing the transmission of the optical signal.

When the metal ions deposit on the mirror electrode, they form a surface layer of metal atoms of uniform thickness, providing a reflecting surface. The cell is operable in at least two modes providing these two extreme conditions, one of which provides a transmissive mode and the other of which provide a reflective mode.

Various metal ions can be used, derived from dissolved metal salts, for example for the deposition of silver or gold or other metal deposits.

FIG. 2 shows the reflectance of a silver or gold layer of different thicknesses and as a function of wavelength. The plots will differ slightly between gold and silver, but the orders of magnitude apply to both metals, and generally the plots in FIG. 2 (and in FIG. 3) can be considered to, apply to gold and silver. Plot 40 shows the reflectance for a layer 50 nm thick over a glass substrate and in a wavelength band covering wavelengths used by optical communications systems. As the thickness is increased, for example to 100 nm in plot 42, the reflectance increases, but this reaches a limit. Plot 44 shows that for a layer of thickness 200 nm, the reflectance is not increased significantly. Thus, the thickness required is no greater than 100 nm (0.1 microns) for high reflectivity metals and for the optical wavelengths of interest. Typically a thickness of 50 nm will suffice, depending upon the required optical loss and a thinner layer may even be sufficient, for example 20 nm.

For a given wavelength of interest, the reflectance will be a function of the metal layer thickness. This can be seen more clearly from FIG. 3, which shows approximately the reflectance of a silver or gold layer at a wavelength of 1550 nm for different thicknesses. The plot shows that the reflectance can be controlled between 0 and 98% by varying the metal layer thickness between 0 and 50 nm.

For a given area, particularly the area of the mirror electrode, the required thickness, for example 50 nm, can be used to determine the number of metal atoms required, which can in turn be used to determine the amount of charge flow required to cause deposition of the metal atoms from the electrolyte on to the mirror electrode. This total required charge can then be converted into a required current flow to the terminals 30, 36 for a specified time. The operation of the cell can thus be controlled using the flow of charge between the electrodes. By halting the flow of charge, the cell remains in its current state, and thus acts as a latching device.

The area of the mirror electrode will be a function of the system in which the component is to be used. Typically, the input signal 12 is the output of a terminated optical fiber focussed to provide a constant envelope output beam, and the mirror electrode will have an area of around between 0.5 mm² and 5 mm², for example around 1 mm². The amount of charge required to deposit a 50 nm thick layer of gold over an area of 1 mm² is 4.8×10⁻⁴ Coulombs, corresponding to a current of 500 mA for 1 mS or 50 mA for 10 mS.

In one preferred embodiment, the deposition of silver is employed because of the reflective properties and the fast electron transfer kinetics. For the deposition of silver, there are two preferred electrolyte compositions. One is silver sulphate, in combination with sodium sulphate (for increasing the conductivity), and the other is silver nitrate, in combination with potassium nitrate. The choice of specific metal salt and other constituents of the electrolyte will be routine to those skilled in the art.

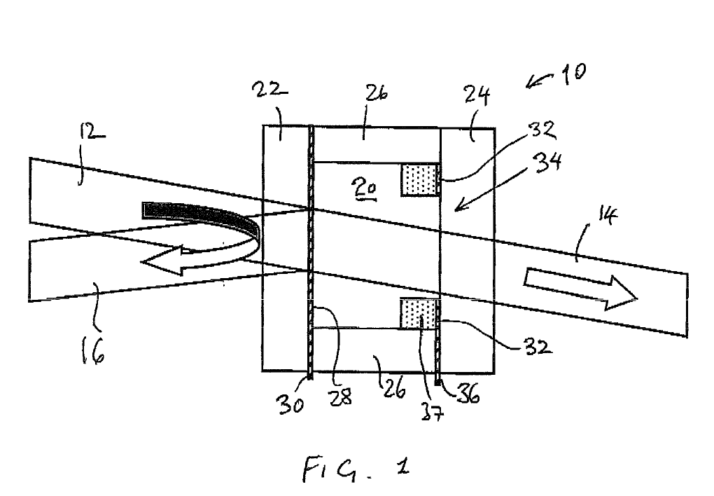

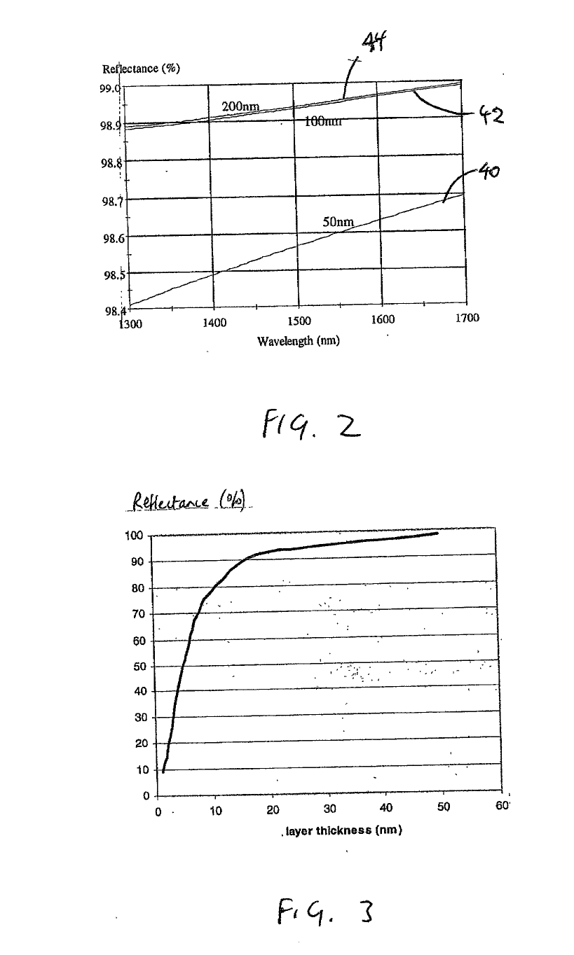

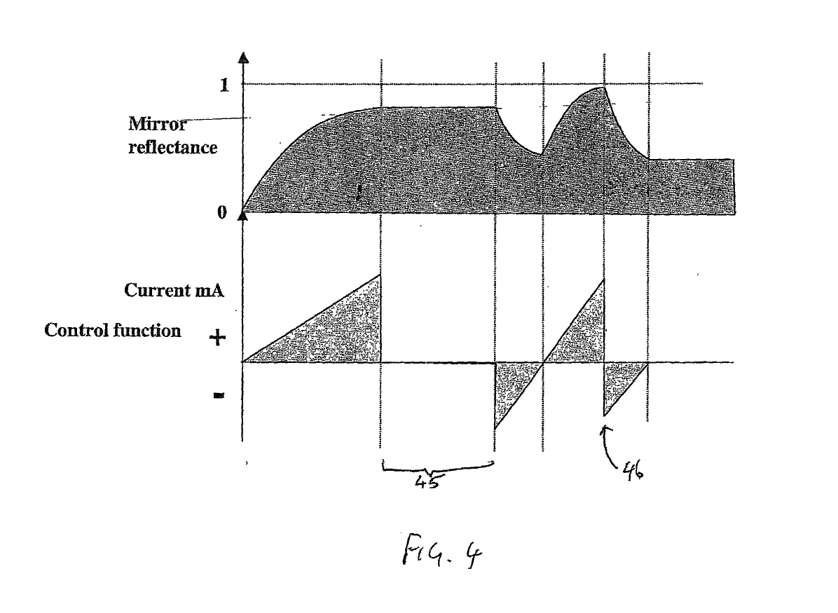

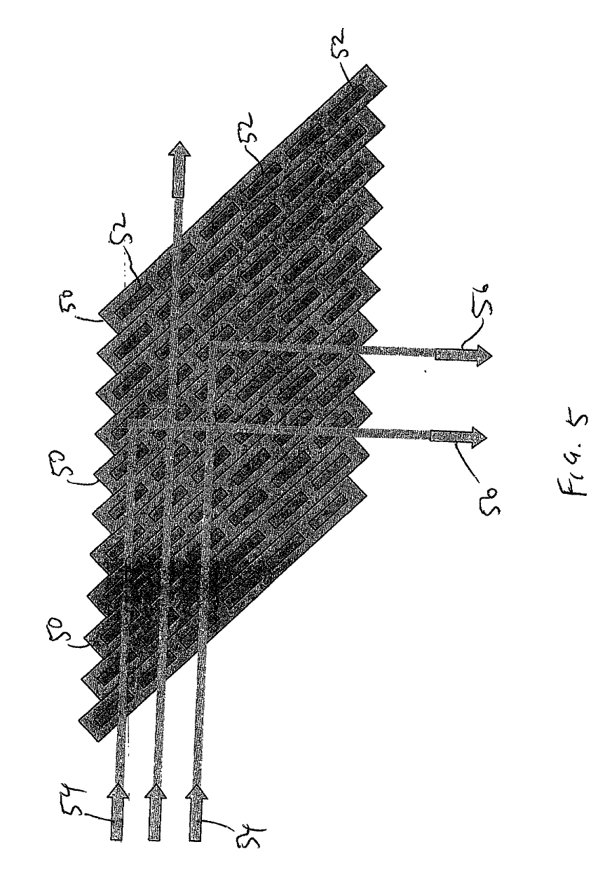

FIG. 4 shows how the cell of FIG. 1 can be controlled to provide variable optical attenuation. The reflectance of the mirror electrode is a function of the thickness of the metal layer on the surface, as shown in FIG. 3. This is a function of the charge flow between the electrodes.

There is a limit to the rate at which metal can be deposited. FIG. 4 shows the use of ramp functions in the current profile, so that the thickness of the layer can be increased over time in a known manner (i.e. slower than the maximum rate). The current profile is selected to enable control of the reflectivity over time in a desired manner. Of course, if a step current profile is applied, the mirror can reach the desired thickness in the shortest time. Region 45 shows that the mirror thickness is maintained when no current is applied. Once the determined maximum thickness has been deposited, for example at time 46, no more current is applied, as this will simply require additional time to return to a transmissive state.

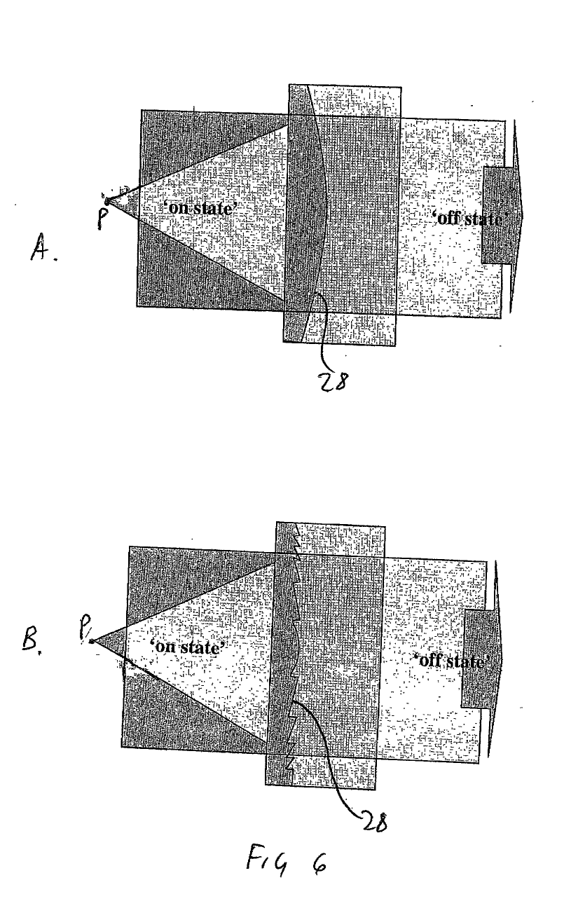

FIG. 5 shows a use of the component of FIG. 1 to provide a switchable mirror array. The array is formed by stacking a number of plates 50, and each plate has a line of cells 52 of FIG. 1 with planar mirror electrodes 28 parallel and aligned with each other. Each plate 50 may be considered as a single optical component, and these components are stacked to define the array shown in FIG. 5. This array has an bank of input ports 54 and a bank of output ports 56 which are aligned with terminated optical fibers. Each input port 54 is aligned with a row of cells 52, and each output port 56 is aligned with a column of cells 52. This structure enables the input signal on any input 54 to be routed to any output 56, by making one of the cells 52 reflecting and by placing all other cells in the path of the signal in a transmissive state. In the example shown, the mirror electrodes are aligned at 45° to the direction of propagation of the input signals, and at 45° to the direction of propagation of the output signals.

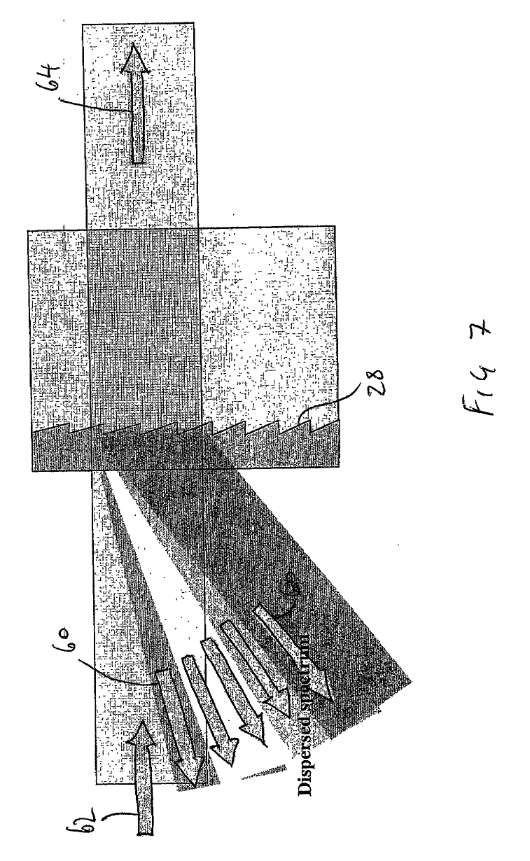

FIG. 5 shows a 2D micromirror array, but the cells of the invention can equally be used in 3D arrays, in which the inputs and outputs are fiber bundles. it is also possible to provide a non-planar mirror electrode 28. As shown schematically in FIG. 6A, the mirror electrode 28 is curved to define a reflective lens surface, which focuses the reflected beam to a point P. This arrangement can be used for focusing an optical signal on to a photodiode detector at point P, for in-line power monitoring. When power monitoring is required, the cell is controlled to provide reflection, whereas during normal operation the cell allows the signal to pass unaffected. To avoid signal distortion in the transmissive state, the refractive indices of the parts forming the cell are chosen to be accurately matched, FIG. 6B shows the same principle, using a Fresnel mirror surface to provide the focusing.

As shown in FIG. 7, the mirror electrode 28 can also be defined as a grating surface, so that a switchable grating may be realised, providing a reflected dispersed spectrum 60 when turned on, but allowing the input signal 62 to pass through the cell to output 64 when turned off.

The optical cell of the invention thus can be used in various applications in which a signal from a fiber or other waveguide is to be selectively switched between two paths, either for monitoring or routing purposes. The specific choice of chemical electrolyte solutions can be made by those skilled in the art, and the component can be manufactured using known techniques.

Although only one configuration for the cell has been given, this is by way of example only. For example, the mirror electrode and the counter electrode do not need to face each other, and the counter electrode may be defined on the sidewall 26. All that is required is a first zone where deposition of metal provides a reflecting surface for an input signal, and a second zone where metal deposit does not impede the transmission of the optical signal.

The nature of the electrical signal profiles used to control the device will be a matter of routine design in order to achieve the required deposition and dissolution of the metal deposit in a controlled manner. In some applications, the control signals need only drive the cell between two states, whereas in others, more accurate driving of the cell into intermediate states will be desirable.

Various other modifications will be apparent to those skilled in the art.

We claim:

1. An optical component for operating on an optical signal within an optical communications system, the component comprising at least one cell having a mirror electrode and a counter electrode, an electrolyte disposed between the mirror and counter electrodes which includes metal ions which are depositable onto the mirror and counter electrodes, wherein the cell is operable in at least two modes providing different reflection and transmission characteristics by depositing different quantities of the metal ions on to the mirror electrode.

2. A component as claimed in claim 1, wherein the mirror electrode is planar, and the wherein one mode is for substantially reflecting an input signal and the other mode is for substantially transmitting an input signal.

3. A switchable mirror array comprising plurality of components as claimed in claim 1 defining an array of calls arranged in rows and columns, wherein the mirror array has a plurality of inputs, each aligned with a row of cells, and a plurality of outputs each aligned with a column of cells.

4. A switchable mirror array as claimed in claim 3 wherein the inputs are aligned at 90 degrees to the outputs, and the mirror electrode of each cell is aligned at 45 degrees to the inputs and outputs.

5. A switchable mirror array as claimed in claim 3, wherein the inputs comprise optical fiber inputs and the outputs comprise optical fiber outputs.

6. A switchable mirror array as claimed in claim 3, wherein each optical component comprises a plurality of cells arranged in a line, and wherein a plurality of the optical components are stacked to define the array ot cells.

7. A component as claimed in claim 1, wherein the mirror electrode is curved to define a reflective lens surface, and wherein one mode is for substantially reflecting an input signal and focusing it, and the other mode is for substantially transmitting an input signal.

8. An optical power monitor for monitoring the optical power of an optical signal, comprising a component as claimed in claim 7, wherein a detector is provided at or near the focal point of the lens.

9. A component as claimed in claim 1, wherein the mirror electrode is shaped to define a reflective Fresnel lens surface, and wherein one mode is for substantially reflecting an input signal and focusing it, and the other mode is for substantially transmitting an input signal.

10. An optical power monitor for monitoring the optical power of an optical signal, comprising a component as claimed in claim 9, wherein a detector is provided at or near the focal point of the lens.

11. A component as claimed in claim 1, wherein the mirror electrode is shaped to define a diffraction grating surface, and wherein one mode is for providing a reflected dispersed spectrum, and the other mode is for substantially transmitting an input signal.

12. An optical spectrum analysis apparatus for analysing an optical signal, comprising a component as claimed in claim 11, wherein a spectral analysis arrangement for receiving the reflected dispersed spectrum.

13. An optical component as claimed in claim 1 comprising a variable optical attenuator wherein the cell is operable in a plurality of modes each providing different reflection and transmission characteristics.

14. A method of operating on an optical signal within an optical communications system, comprising:
aligning the signal with a cell having a mirror electrode and a counter electrode and an electrolyte disposed between the mirror and counter electrodes which includes metal ions which are depositable onto the mirror and counter electrodes;
selectively operating the cell in one of at least two modes, the at least two modes providing different reflection and transmission characteristics by depositing different quantities of metal ions on to the mirror electrode.

15. A method as claimed in claim 14, wherein the at least two nodes comprise a first mode in which the cell is substantially transmissive for the input signal and a second mode in which the cell is substantially reflective for the input signal.

16. A method as claimed in claim 14, wherein the optical signal is provided to the component from an optical waveguiding medium.
